(19) United States
(12) Patent Application Publication
(10) Pub. No.: US 2008/0228740 A1
(43) Pub. Date: Sep. 18, 2008

(54) Systems and methods for searching a network of distributed content servers

(76) Inventors: Benjamin Weiss, Portola Valley, CA (US); Stephen Currie, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/725,059

(22) Filed: Mar. 16, 2007

(51) Int. Cl. G06F 17/30

(52) U.S. Cl. 707/4; 707/E17.014

(57) ABSTRACT

A system that provides search results for searches of a distributed network of content servers includes a server that receives search request from a given user, wherein the user provides a search parameter; a searchable database having a plurality of web-usage histories stored therein; and a search engine module in communication with the database, the search engine module receives the search parameter and uses the search parameter to search at least a portion of the plurality of web-usage histories stored in the database and generate search results therefore, wherein the server provides the search results to the given user.

### BACKGROUND OF THE INVENTION

The Internet can be described as a distributed network of computers or servers that employ a common communication protocol, Transmission Control Protocol/Internet Protocol (TCP/IP). This distributed network is literally world wide and is comprised of thousands of servers. The Internet is not static. Rather, it is always evolving. New servers are constantly being added to the Internet.

The Internet includes the World Wide Web (WWW), which can be described as a distributed network of computers or servers that utilize Hypertext Transmission Protocol (HTTP) to transfer content carried in documents and multimedia files formatted in Hypertext Markup Language (HTML). A single server in the WWW can host multiple websites. A website on the WWW provides content in the form of HTML documents or WebPages.

In order to access a document on the WWW, a person can use a computing device or similar device having a browser such as Internet Explorer, Netscape Navigator, Safari, etc. The browser retrieves content from a web server, and then displays the content. While browsers enable people to surf and retrieve content and to have the content displayed to them, browsers by themselves don't help people find content efficiently. There is so much content on the WWW—literally billions of web pages—that finding content, which a person regards as being useful, by web-surfing is akin to finding the proverbial needle in the haystack.

To facilitate the finding of content on the WWW, a person might use a conventional search engine such as those provided by Google™, Yahoo Search™, Microsoft™, and Apple™, Netscape™, among others. These conventional search engines use differing algorithms for finding and displaying search results. Typically, a person using a conventional search engine will enter some search parameters, and the conventional search engine will then conduct the search.

A problem associated with many conventional search engines is determining the proper search criteria. If the person does a search using search criteria that are too broad, then the search engine may return hundreds, if not thousands, hits (search results), which once again leaves the person with the proverbial task of looking for a needle (a relevant/useful result) in the haystack of search results. On the other hand, if the person conducts a search using search criteria that are too narrow, then search results that the person might have considered to be relevant might not be included in the search results. Thus, a heretofore unaddressed need exists in the industry to address the aforementioned deficiencies and inadequacies.

### SUMMARY OF THE INVENTION

Embodiments of the present invention provide systems and methods for providing search results for searches related to content in a distributed network of content servers. Briefly described, in architecture, one embodiment of the system, among others, can be implemented as follows. A system for providing search results, the system comprising: a server that receives search request from a given user, wherein the user provides a search parameter; a searchable database having a plurality of web-usage histories stored therein; and a search engine module in communication with the database, the search engine module receives the search parameter and uses the search parameter to search at least a portion of the plurality of web-usage histories stored in the database and generate search results therefore, wherein the server provides the search results to the given user.

The present invention can also be viewed as providing methods for providing search results. In this regard, one embodiment of such a method, among others, can be broadly summarized by the following steps: receiving, from a particular user, a search request having search parameters; searching a web-usage history, stored in a database, using the search parameters, wherein the web-usage history includes historical web-usage information for a given user of the search provider; and providing the particular user with search results based at least upon the search of the web-usage history.

Another embodiment of such a method, among others, can be broadly summarized by the following steps: storing a plurality of web-usage histories in a database; receiving a search request having search parameters included therein; searching the database using the search parameters; and providing a historical web-usage search results based upon the search of the database.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a block diagram illustration of users communicating with a Past-Web-Usage-Search System.

FIG. 1B illustrates embodiments of a network communication device used by the users of FIG. 1A to communicate with the PWUSS of FIG. 1A.

FIG. 2 is a block diagram of a network communication device.

FIG. 3 is a block diagram of a computer system of the PWUSS of FIG. 1A.

FIG. 4 is a block diagram of a message.

FIG. 5 is a block diagram of a window for providing user-input.

FIG. 6 is a flow chart of a process for searching an archive of web-usage histories.

### DETAILED DESCRIPTION OF THE PREFERRED EMBODIMENTS

A Past-Web-Usage-Search System (PWUSS) facilitates the searching of distributed networks such as the WWW and/or the Internet. For the sake of clarity distributed networks are discussed herein in terms of the World Wide Web or Web. However, such discussion is not intended as a limitation. The principles described herein can be applied to other distributed networks.

In one embodiment, a PWUSS is membership based and facilitates the searching of the WWW for its members. In operation, a person applies for a membership with the PWUSS, and then, upon membership being granted the person creates a social-network. A first person's social-network may be created by the first person sending PWUSS membership-invitations to other persons and then having some of the invitees join the first person's social-network. (A PWUSS membership-invitation is an invitation to join the social-network, at the PWUSS, of the person sending PWUSS membership-invitation.)

The first person may be considered a first-level member in the first person's social-network, and the people who join the first person's social-network may be considered second-level members of the first person's social-network. When a second person joins the social-network of the first person, the second person may then create his or her own social-network in which the second person may be considered a first-level member, and persons who join the second person's social-network may be considered second-level members of the second person's social-network.

Normally, it is not necessary for a person wanting to create their own social-network at the PWUSS to join another person's social-network. Typically, any person desiring a social-network can enroll at the PWUSS and then invite others to join his or her social-network.

The PWUSS accumulates web-usage information from the people (members) who join the PWUSS. The PWUSS provides the members with web-usage monitors. The members install the web-usage monitors on communication devices used by the members to access and retrieve content from a distributed network of content servers such as the Internet and/or Web. When a member uses his or her communication device having an installed web-usage monitor, the web-usage monitor reports web-usage information back to the PWUSS. The web-usage information provided to the PWUSS is generally related to the content retrieved by the member. For example, the web-usage information may include Uniform Resource Locators (URLs) of retrieved web-pages and meta-data included in retrieved web-pages.

The web-usage information of the members of the PWUSS may be accumulated in a historical database. The PWUSS uses the historical database to apply collective-wisdom or “member-wisdom” to web searches. When a member of the PWUSS wants to do a web search, the member provides the PWUSS with search parameters. The PWUSS then searches the historical database using the provided search parameters and provides search results, which may be related to the content of the historical database, to the member requesting the search.

In one embodiment, when the PWUSS receives web-usage information from a member of the PWUSS, the PWUSS may then associate the web-usage information with that member and create a user-web-usage history that is associated with that member. The PWUSS may then maintain a database of user-web-usage histories. When a member of a given social-network of the PWUSS does a web search, the PWUSS may then conduct the search using the user-web-usage histories belonging to the members of the given social-network. In some embodiments, the user-web-usage history belonging to the member requesting the search is not included in the searched user-web-usage histories. The user-web-usage history of the member requesting the search may be excluded from the searched user-web-usage histories so as to not bias the search results. In yet other embodiments, the member requesting the search can select which user-web-usage histories will be used by the PWUSS.

As an example of the collective member-wisdom consider the following. A first person creates a social-network. By its very nature, the social-network is selective; members are added by invitation of the first-level member. When the first person does a search, the first person may select which user-web-usage histories are used in the search. Thus, the first person may select those members having a common characteristic. For example, if the first person is doing a search that is related to medicine or physiology, the first person might select only those members of his or her social-network who are medical doctors or have some medical training. Thus, the search results may be culled, or otherwise processed, from the user-web-usage histories of doctors or those with medical training. By restricting the search to members who have a common characteristic that is relevant to the search request the results of the search may be, and probably will be, more relevant than the results that would be provided from a conventional search engine.

As another example, assume that the first person wants to buy a gift for his or her aunt, and his or her aunt is a member of his or her social-network. The first person might do a search related to music and restrict the search to his or her aunt's user-web-usage history. Thus, the search results are more likely to include web sites that his or her aunt has frequented. Consequently, the first person may visit the same web sites as his or her aunt has visited. Seeing as how the aunt has visited those web sites, it may be assumed that the aunt held some interest for the aunt, and consequently, the first person is more likely to find something on those web sites that his or her aunt finds interesting.

In one embodiment, the PWUSS may receive web-usage information from the members of a given social-network and accumulate the received web-usage information into a collective social-network-web-usage history, which may then be associated with the members of the given social-network. When a member of the given social-network does a web search, the PWUSS may then conduct the search using the social-network-web-usage history. In some embodiments, there may be a default setting that excludes the user-web-usage history of the first-level member from the social-network-web-usage history so that searches performed by the first-level member won't be biased by his own web usage.

In yet another embodiment, when a person does a search at the PWUSS, the person may instruct the PWUSS to use user-web-usage histories including those user-web-usage histories belonging to people who are not in the same social-network as the person. The person might instruct the PWUSS to use all available user-web-usage histories or a subset of the user-web-usage histories. The person might specify which user-web-usage histories to use or provide instructions or parameters from which the PWUSS then determines the appropriate subset of user-web-usage histories. For example, when a person enrolls with the PWUSS, the enrollment process may require, or request, that the person provide information related to the person such as occupation, place of occupation, education, interests, hobbies, martial status, income, date of birth, astrological sign, location of birth, nationality, religious affiliations, etc. This enrollment information may then be associated with the person's web-usage history.

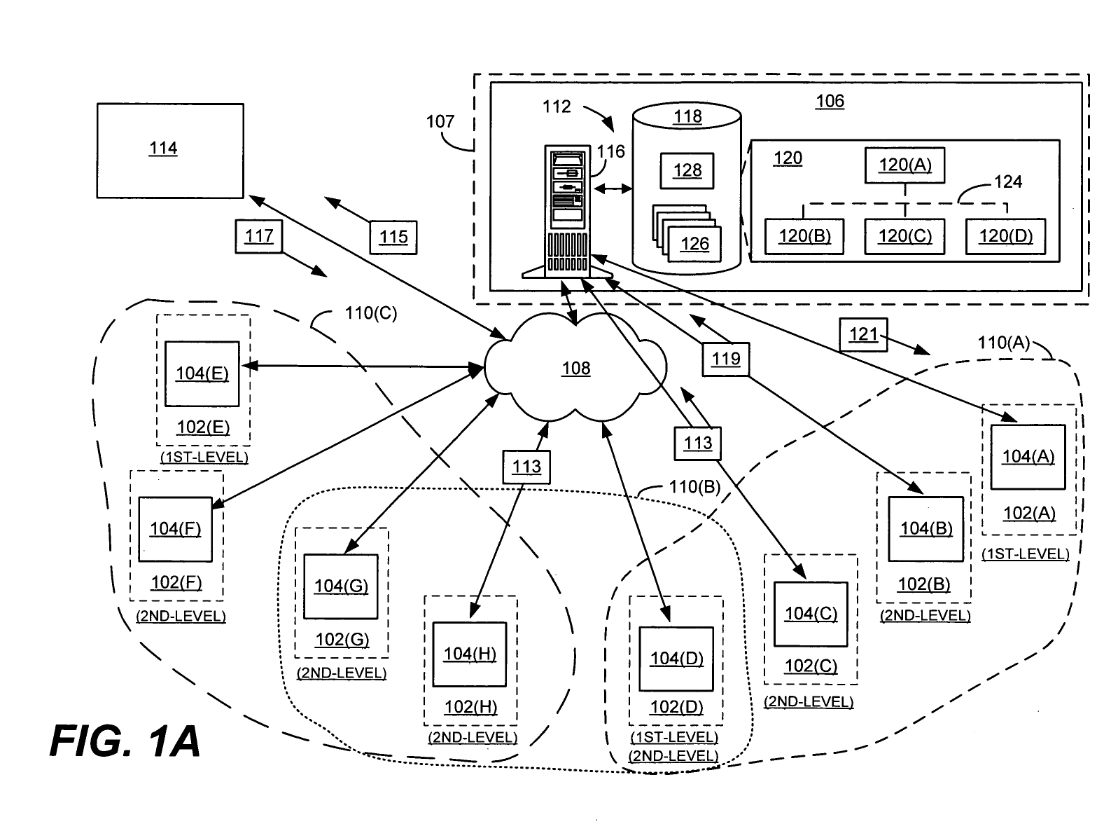

When a person does a search using the PWUSS, the person can specify a predetermined member-characteristic (or characteristics). The PWUSS will use the member-characteristic and the enrollment-information provided by the members of the PWUSS to determine which members have the member-characteristic, and then uses the web-usage histories of those selected members in the search. As an example, a first person may do a search related to heart disease and may specify a member-characteristic such as heart surgeon for occupation. In that case, the PWUSS will determine which members are, by occupation, heart surgeons, and then use the web-usage histories of those selected members. This embodiment allows a member of the PWUSS to grow the pool of searchable web-usage histories from his or her own social-network to all members of the PWUSS. Having described the principles of the PWUSS in generality, various embodiments will be described in with respect to FIGS. 1A and 1B through 6 below.

In FIG. 1A, a plurality of users 102(A)-102(C) are in communication with a central office 106 of a service provider 107 via network communication devices 104(A)-104(C), respectively. Users 102(D)-102(H) are in communication with a distributed network 108 via network communication devices 104(D)-104(H), respectively. Typically, the distributed network 108 is the Internet or World Wide Web (Web) or another network of distributed content servers. Hereinafter, the distributed network is discussed as the Web, but this is done merely for the sake of clarity and is not intended as a limitation. Similarly, the service provider 107 may be described in terms of an Internet Service Provider, but this is also done merely for the sake of clarity and is not intended as a limitation.

The users 102(A)-102(D) belong to a first social-network 110(A). The users 102(D), 102(G), and 102(H) belong to a second social-network 110(B), and the users 102(E)-102(H) belong to a third social-network 110(C). Each of the social-networks 110(A)-110(C) has a first-level member and multiple second-level members. Typically, the first-level member of a given social-network is the member who knows the other members of the given social-network. For the sake of clarity, and as a non-limiting example, user 102(A) is described as the first-level member of the social-network 110(A); user 102(D) is described as the first-level member of social-network 110(B); and user 102(E is described as the first-level member of social-network 110(C). It should be clear that a user can be concurrently a “first-level member” and a “second-level member.” For example, user 102(D) is a second-level member of the social-network 110(A) and the first-level member of social-network 110(B). Furthermore, users 102(G) and 102(H) are concurrent second-level members of social-networks 110(B) and 110(C) and may also be first-level members of their own social-networks (not shown).

In one embodiment, the central office 106 of the service provider 107 includes a Past-Web-Usage-Search System (PWUSS) 112. However, it should be noted that in other embodiments, the PWUSS 112 may be located at a different location and/or the PWUSS may be provided by a different entity, e.g., entities that are not ISPs such as, but not limited to, search entities.

As will be explained in detail hereinbelow, the network communication devices 104(A)-104(H) may be configured to provide web-usage information 113 to the PWUSS 112, and the PWUSS 112 is configured to use received web-usage information 113 to facilitate web searches of the network 108

Also shown in FIG. 1A is a web-search engine 114. The web-search engine 114 is a conventional search engine configured to receive user input and provide search results back. Web-search engines such as those provided by Google™, Yahoo Search™, Microsoft™, and Apple™, Netscape™, among others, are well known in the art, and consequently, the web-search engine 114 is not described in detail.

In one embodiment, the PWUSS 112 may be configured to provide search parameters 115 to the web-search engine 114 and receive the conventional web-search results 117 thereof. The PWUSS 112 may provide the conventional web-search results 117 to users 102(A)-102(H) and/or use the conventional web-search results 117 from the web-search engine 114.

The PWUSS 112 may include a computer system 116 and a database 118. Among other things, the computer system 116 includes the hardware, software, and/or firmware for providing electronic social-network capabilities to the users 102(A)-102(H). Among other things, the computer system 116 receives web-usage information from the network communication devices 104(A)-104(H) and provides the content of the received web-usage information to the database 118. The computer system 116 may also receive PWUSS search requests 119 from the users 102(A)-102(H). The computer system 116 may search the database 118 in response to receiving a PWUSS search request 119, and provide a PWUSS search result 121 to the user who provided the PWUSS search request 119.

The database 118 includes member-profiles 120. For the sake of clarity, member profiles 120(A)-120(D), which correspond to the member-profiles for users 102(A)-102(D), are illustrated as linked into an electronic social network 124. Typically, the database 118 includes member-profiles 120 for multiple electronic social-networks 124. The database also includes user-web-usage histories 126. Each one of the user-web-usage histories 126 is associated with a specific member-profile. When a specific network communication device 104 provides web-usage information 113 to the computer system 116, the computer system 116 may determine which network communication device 104 provided the web-usage information 113 and which user 102 is associated with the network communication device 104, and then retrieve the user's user-web-usage history 126. The computer system 116 may then include content from the received web-usage information 113 in the retrieved user-web-usage history 126.

In another embodiment, when the computer system 116 receives web-usage information 113, the computer system 116 may determine which user caused the web-usage information 113 to be sent to the computer system 116. (The user may have caused the web-usage information 113 to be sent simply by receiving web content on a network communication device having an installed web-usage monitor.) The computer system 116 may then retrieve the user's web-usage history 126 and then include content from the received web-usage information 113 in the retrieved user-web-usage history 126.

In some embodiments, the database 118 may include social-network-web-usage histories 128. In some embodiments, the PWUSS 112 may maintain a social-network-web-usage history 128 for each electronic social-network 124 maintained by the PWUSS 112. A given social-network-web-usage history 128 may be an aggregation of web-usage information 113 provided by members of the given electronic social-network 124. When the computer system 116 receives web-usage information 113, the computer system 116 may identify an electronic social-network 124, and then include content from the received web-usage information 113 in the given social-network-web-usage history 128 associated with the given electronic social-network 124. The computer system 116 may identify the given electronic social-network 124 based upon information included in the web-usage information 113 and/or by identifying the user who caused the web-usage information 113 to be sent to the computer system 116.

Furthermore, in one embodiment, the service provider having the PWUSS 112 may prevent people who are not customers of the service provider from establishing their own electronic social-networks. In other words, first-level membership can be restricted to customers of the service provider. In the embodiment illustrated in FIG. 1A, the users 104(A)-104(C) might be customers or subscribers of the service provider 107, and the users 104(D)-104(H) might be members of the PWUSS 112.

FIG. 1B illustrates various embodiments of the network communication device 104(A). Embodiments of the other network communication devices 104(B)-104(H) will generally include embodiments illustrated in FIG. 11B. The network communication device 104(A) can comprise a range of devices including workstation 150, laptop computer 152, personal digital assistant 154 and tablet computer 156.

The workstation 150 comprises a computer 158, and various input/output devices such as a keyboard 160, a mouse 162 and a monitor 164. Each of the examples of the network communication device 104(A) comprises a respective display for presenting, among other things, a graphical-user interface and content to the user 102(A) of the network-communication device 104(A). The monitor 164 includes a cathode-ray tube, which generates display 166. The laptop computer 152 includes a thin-film transistor active matrix display 168. The personal digital assistant 154 and the tablet computer 156 include a liquid crystal display 170 and a liquid crystal display 172, respectively. In addition to having a display, each of the user devices includes one or more input/output mechanisms that permit an operator of the device to, among other things, enter commands on a graphical-user interface, send requests to network 108, and display content from the network 108.

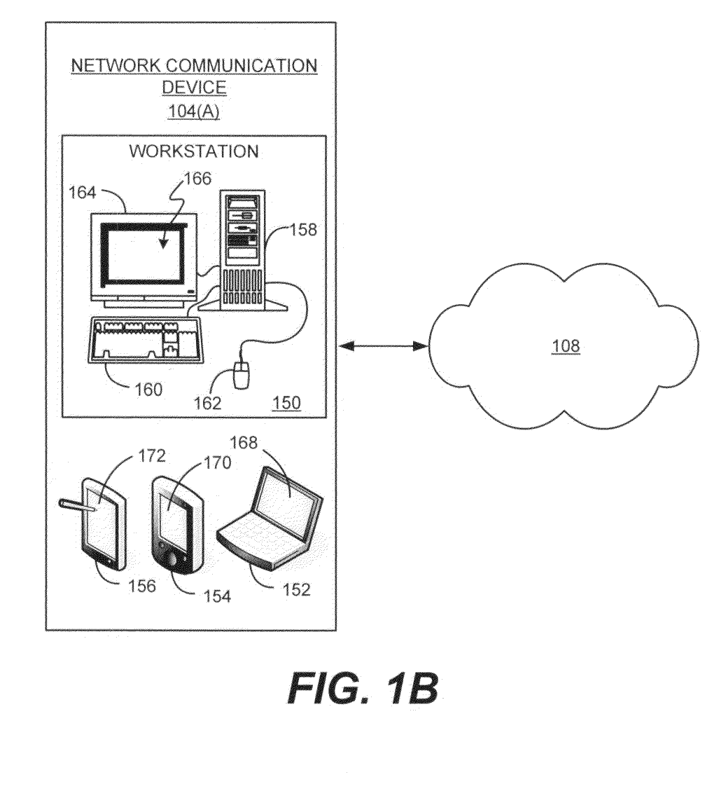

FIG. 2 is a schematic diagram illustrating an embodiment of the network communication device 104(A) of FIGS. 1A and 1B. Generally, in terms of hardware architecture, as shown in FIG. 2, the network communication device 104(A) includes a processor 202, memory 204 and one or more user input and/or output (I/O) devices 206 (or peripherals) that are communicatively coupled via a local interface 208. The local interface 208 can be, for example but not limited to, one or more buses or other wired or wireless connections, as is known in the art. The local interface 208 may have additional elements, which are omitted for simplicity, such as controllers, buffers (caches), drivers, repeaters, and receivers, to enable communications. Further, the local interface 208 may include address, control, and/or data connections to enable appropriate communications among the aforementioned components.

The processor 202 is a hardware device for executing software, particularly that stored in memory 204. The processor 202 can be any device for executing software instructions. The memory 204 can include any one or combination of volatile memory elements (e.g., RAM, such as DRAM, SRAM, SDRAM, etc.)) and nonvolatile memory elements (e.g., ROM, flash memory, etc.). Moreover, the memory 204 may incorporate electronic, magnetic, optical, and/or other types of storage media. Note that the memory 204 can have a distributed architecture, where various components are situated remote from one another, but can be accessed by the processor 202.

The user I/O devices 206 may include input devices, for example but not limited to, a keyboard, mouse, scanner, microphone, a touch sensitive display etc. Furthermore, the user I/O devices 206 may also include output devices, for example but not limited to, a printer, display, etc. I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in network interface device 210, which enables network communication device 104(A) to communicate with the network 108.

Software stored in memory 204 may include one or more separate programs, each one of which comprises an ordered listing of executable instructions for implementing logical functions. In the example of FIG. 2, the software in the memory 204 includes an operating system 212, a browser 214, and a PWUSS client module 216 Among other things, the operating system 212 essentially controls the execution of the PWUSS client module 216 and provides scheduling, input-output control, file and data management, memory management, and communication control and related services.

The browser 214 is a source program, executable program (object code), script, or any other entity comprising a set of instructions to be performed. When implemented as a source program, the browser 214 is translated via a compiler, assembler, interpreter, or the like, which may or may not be included within the memory 204, so as to operate properly in connection with the O/S 212. Furthermore, the browser 214 can be written in one or more object oriented programming languages, which have classes of data and methods, or procedure programming languages, which have routines, subroutines, and/or functions.

Typically, the browser 214 is a conventional web-browser known to those skilled in the art. The browser 214 receives content conforming to an Internet Protocol such as, but not limited to, Hyper Text Transfer Protocol (HTTP), Hypertext Markup Language (HTML), Standard Generalized Mark-Up Language (SGML), etc. The browser 214 is configured to display received content of the I/O device 206.

The PWUSS client module 216 may be a source program, executable program (object code), script, or any other entity comprising a set of instructions to be performed. When implemented as a source program, the PWUSS client module 216 is translated via a compiler, assembler, interpreter, or the like, which may or may not be included within the memory 204, so as to operate properly in connection with the O/S 212. Furthermore, the PWUSS client module 216 can be written in one or more object oriented programming languages, which have classes of data and methods, or procedure programming languages, which have routines, subroutines, and/or functions.

In some embodiments, the PWUSS client module 216 includes a web-usage monitor module 218 and a user interface module 220. The web-usage monitor module 218 is configured to interface with the browser 214. The web-usage monitor module 218 may include logic for, among other things, determining web-usage information and providing the web-usage information 113 to the PWUSS 112. Typically, the web-usage information 113 from a received page of content includes content information such as, but not limited to, meta-data, contents of the page (including text and images), date accessed, time spent on the page, and the URL for the page of content. In some embodiments, the web-usage monitor module 218 may include logic for, among other things, determining content information from a page of content. In addition to finding meta-data, the web-usage monitor module 218 may read a page of content and determine content information therefrom.

In some embodiments, the web-usage monitor module 218 may be configured as browser plug-in for browser 214. The web-usage monitor module 218 may provide web-usage information to the PWUSS 112 in a periodic or systematic manner. As a non-limiting example, the web-usage monitor module 218 may be configured to report web-usage information to the PWUSS 112 every couple of minutes or so. As another non-limiting example, when the browser 214 is displaying content of a given web page, the web-usage monitor module 218 can determine web-usage information for the given web page and provide the web-usage information 113 before and/or during the loading of another web-page into the browser 212. As another example, the web-usage monitor module 218 can accumulate web-usage information while the browser 214 is being executed by the processor 202 and provide the accumulated web-usage information 113 prior to termination, or during termination, and/or after termination of the execution of the browser 214.

The user interface 220 may be configured to provide one or more windows in a display device and receive user input. The user interface 220 provides a mechanism that allows the user to, among other things, organize members of the user's social-network into groups, select one or more groups for use in a search, select one or more member of the user's social-network for use in a search, and provide weighting factors. The user interface 220 may be configured to provide, among other things, user selections to the PWUSS 112. The user interface 220 may also be configured to provide a window for controlling aspects of the web-usage monitor 218. For example, in one embodiment, the user-interface 220 can be used to, among other things, turn the web-usage monitor on and off.

In some embodiments, the user interface 220 includes a listing of members in a particular electronic social network. The listing may include the names of the members, the usernames of the members, or other identifier of the members. Thus, in some embodiments, the list of members can be used to identify which member-profiles for members of the user's social-network interface 220 should be searched or excluded from a search, to provide weighting factors, etc.

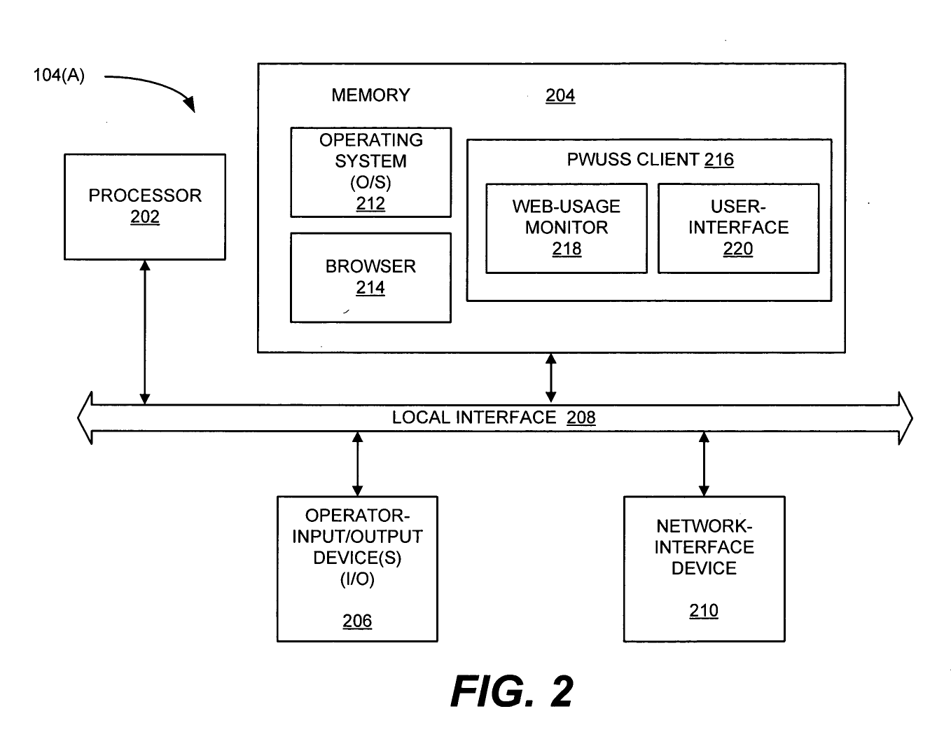

FIG. 3 is a schematic diagram illustrating an embodiment of the PWUSS 112 of FIG. 1A. Generally, in terms of hardware architecture, as shown in FIG. 3, the PWUSS 112 includes a processor 302, memory 304, a database 306, one or more operator input and/or output (I/O) devices 308 (or peripherals), and one or more network-interface devices 330, all of which are communicatively coupled via a local interface 310.

The local interface 310 can be, for example but not limited to, one or more buses or other wired or wireless connections, as is known in the art. The local interface 310 may have additional elements, which are omitted for simplicity, such as controllers, buffers (caches), drivers, repeaters, and receivers, to enable communications. Further, the local interface 310 may include address, control, and/or data connections to enable appropriate communications among the aforementioned components.

The processor 302 is a hardware device for executing software, particularly that stored in memory 304. The processor 302 can be any custom made or commercially available processor, a central processing unit (CPU), an auxiliary processor among several processors associated with the PWUSS 112, a semiconductor based microprocessor (in the form of a microchip or chip set), or generally any device for executing software instructions.

The memory 304 and/or database 306 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disc read-only memory (CDROM), etc.). Moreover, the memory 304 and/or the database 306 may incorporate electronic, magnetic, optical, and/or other types of storage media. Note that the memory 304 and/or the database 306 can have a distributed architecture, where various components are situated remote from one another, but can be accessed by the processor 302. The database 306 includes a plurality of user-web-usage histories 326 and a plurality of member-profiles 328.

Software in the memory 304 may include one or more separate programs, each of which comprises an ordered listing of executable instructions for implementing logical functions. In the example of FIG. 3, the software in the memory 304 includes an operating system 312 and a Past-Web-Usage-Searcher (PWUS) 314, which comprises an archival search engine module 316, a social-network manager module 318, a search result ranker module 320, a member directory 322, and a user-interface 324. The operating system 312 essentially controls the execution of computer programs and provides scheduling, input-output control, file and data management, memory management, and communication control and related services.

I/O devices 308 may include input devices, for example but not limited to, a keyboard, mouse, scanner, microphone, etc. Furthermore, I/O devices 308 may also include output devices, for example but not limited to, a printer, display, etc. I/O devices 308 may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in network-interface device 330, which enables PWUS 314 to communicate with network coupled devices. I/O devices 308 enable a local operator to configure programs and/or data associated with PWUS 314.

When PWUS 314 is in operation, the processor 302 is configured to, among other things, execute software stored within the memory 304, to communicate data to and from the memory 304, enroll users, manage electronic social-networks, receive PWUSS search requests 119, search the database 306, provide PWUSS search results 121, and generally control operations of the PWUS 314 pursuant to the software. The PWUS 314 and the O/S 312, in whole or in part, but typically the latter, are read by the processor 302, perhaps buffered within the processor 302, and then executed.

When the PWUS 314 is implemented in software, as is shown in FIG. 3, it should be noted that the PWUS 314 can be stored on any computer-readable medium for use by or in connection with any computer related system or method. In the context of this document, a “computer-readable medium” is an electronic, magnetic, optical, or other physical device or means that can contain or store a computer program for use by or in connection with a computer related system or method. The PWUS 314 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM), an electrically erasable programmable read-only memory (EEPROM), or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more modules such as the archival search engine module 316, the Social-Network Manager 318, the Result Ranker 320, the Member Directory 322, and/or the user-interface 324 of the PWUS 314 are implemented in hardware the PWUS 314 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field programmable gate array (FPGA), etc.

Among other things, the social-network manager module 318 includes logic for enrolling users in the PWUSS 112, creating electronic social-networks 124, modifying existing social-networks 124 (e.g., adding and/or deleting members form an existing social-network), controlling access to the PWUSS 112, managing received web-usage information 113, managing the member directory 322, managing web-usage histories 326, and managing member-profiles 328. The member directory 322 includes member identifiers and may include electronic social-network identifiers. The member directory 322 may be used to determine the electronic social-network or electronic social-networks of which a given user is a member and/or vice versa, to determine the users who are included in a particular electronic social-network.

In a preferred embodiment, web-usage information 113 from a given user includes a user-identifier. The PWUS 314 may use the user-identifier to identify a specific web-usage history 326 that may be associated with the user-identifier. Typically, after the PWUS 314 has received web-usage information 113 from the given user, the PWUS 314 retrieves the given user's web-usage history 326. The PWUS 314 may also use the member directory 322 to identify the particular web-usage history 326 belonging to the given user. The PWUS 314 may be configured to modify the given user's web-usage history 326 to include information contained in the web-usage information.

In some embodiments, the database 306 includes social-network-web-usage histories 332. Typically, a given social-network-web-usage history 332 is associated with a given electronic social-network having particular users 102 as its members, and the given social-network-web-usage history includes web-usage information 113 provided by some or all of the particular users. Typically, a given social-network-web-usage history is identified by a particular electronic social-network identifier.

Among other things, the user-interface module 324 includes logic for providing a user interface to the PWUSS 112. Typically, users access the PWUSS 112 via the browser 212 on their communication devices 104(A)-104(I). Thus, the user-interface module 324 may be configured to provide web pages for, among other things, enrolling users in the PWUSS 112, creating social-networks, modifying existing social-networks, e.g., adding and/or deleting members to an existing social-network, modifying member-profiles 328. The user-interface module 324 may also be configured to enable a user to provide search parameters, weighting factors, which may be used by the result ranker, provide weights, member restrictors for selecting members of a given electronic social-network, and member-characteristics for selecting characteristics of members whose user-web-usage histories are used in a search.

The archival search engine module 316 is configured to receive PWUSS search requests 119 and search the user-web-usage histories 326. Typically, PWUSS search requests 119 include search parameters such as, but not limited to, search strings and membership-information. Search strings may include words and/or phrases and/or other identifiers of content that are to be found in the web pages that comprise the search results or words and/or phrases and/or other identifiers of content that are not to be found in the web pages that comprise the search results. Membership-information may include a member-identifier such as, but not limited to, a username and/or an electronic social-network-identifier. The search engine 316 may also be configured to provide search strings to the conventional search engine 114 and to receive the results from the conventional search engine 314.

Among other things, the result ranker 320 receives search results from the archival search engine 316 and rates the results. In some embodiments, the result ranker 320 may receive non-historic-usage search results, i.e., search results that are not derived from searching the user-web-usage histories 326, and/or social-network-web-usage histories 332, and historic-usage search results, i.e., search results derived from searching the archived user-web-usages histories 326 and/or the archived social-network-web-usage histories 332.

The result ranker 320 may apply an algorithm combine and rank the non-historic-usage search results and the historic-usage search results. The result ranker 320 may apply weighting factors provided by the member conducting the search. The weighting factors may be applied to single or multiple user-web-usage histories 326 and/or to non-historic-usage search results. For example, a user belonging to a particular social-network may decide to research music. The user appreciates the musical tastes of some members of his or her social network above the musical taste of other members in his or her social network. Thus, the user may provide weight factors for various members of his or her social network. The result ranker 320 will apply the weight factors when ordering the results of the search.

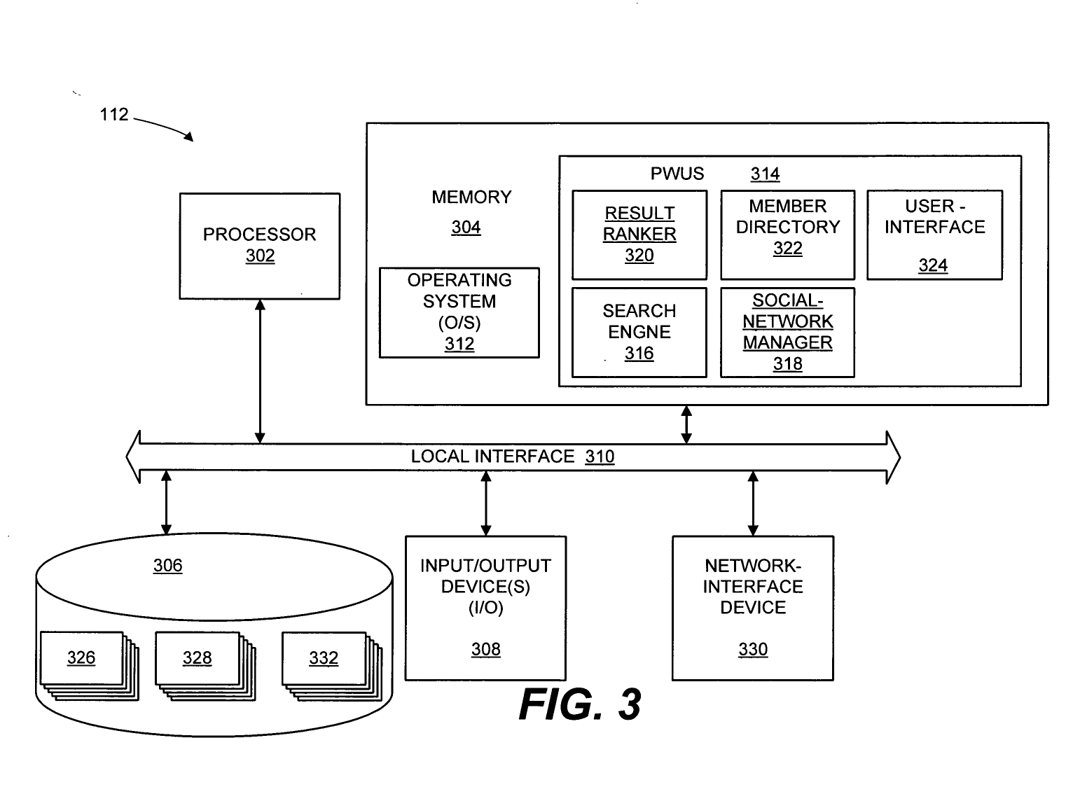

FIG. 4 illustrates an exemplary message 400 that may be used to carry information to the PWUSS 112 and from the PWUSS 112. Typically, the message 400 includes a recipient field 402, a sender field 404, and a payload 406. When the message 400 is a message for the PWUSS 112, as non-limiting examples, the message 400 may be web-usage information 113 or a PWUSS search request 119. The recipient field 402 carries an identifier for the PWUSS 112 such as an IP address. The sender field 404 carries a sender identifier of the sender of the message.

In some embodiments, the sender identifier may be a username, which may be used with the member directory 322 to identify the sender of the message 400. In some embodiments, sender field 404 may include a device identifier such as the IP address of the network communication device from which the message 400 was sent. In some embodiments, the web-usage monitor 218 provides a sender identifier, which is carried in the sender field 404, in the web-usage information 113.

If the message 400 is web-usage information 113, the payload field 406 may carry information related to downloaded web pages such as URLs of downloaded web pages, meta data, and other information related to web usage. On the other hand, if the message 400 is a PWUSS search request 119, the payload field 406 may carry search parameters, member weighting factors, member restrictors for determining which member-profiles, which correspond to particular users of a given social network, are to excluded or included in a search, and/or member characteristics for determining which member-profiles, which correspond to particular users of a given social network, are to excluded or included in a search based upon the characteristics of the particular users. Nonlimiting member characteristics include occupation, gender, age, etc.

When the message 400 is from the PWUSS 112, the message 400 is typically a PWUSS search results 121. In that case, the recipient field 402 may carry an identifier such as an IP for a particular network communication device 104. The sender field 404 may carry the IP address of the PWUSS 112. The payload field 406 may carry the search results, which may include historic-usage-search results and non-historic-usage-search results. Historic-usage-search results are generated by the archival search engine 316 searching the database 306 in response to a PWUSS search request 119. Non-historic-usage-search results include search results from a conventional search engine such as search engine 114.

It should be remembered that in some embodiments, the network communication devices 104 interface with the PWUSS 112 via the browser 214. In this mode of operation, the browser 214 may be used to pass information to the PWUSS 112. Information passed by the browser 214 includes, but is not limited to, web-usage information 113, and PWUSS search requests 119. Typically, in this mode of operation, the user has logged into the PWUSS 112. When the user logs into the PWUSS 112, PWUS 314 may use the member directory 322 to identify the electronic social-network 124 of the user.

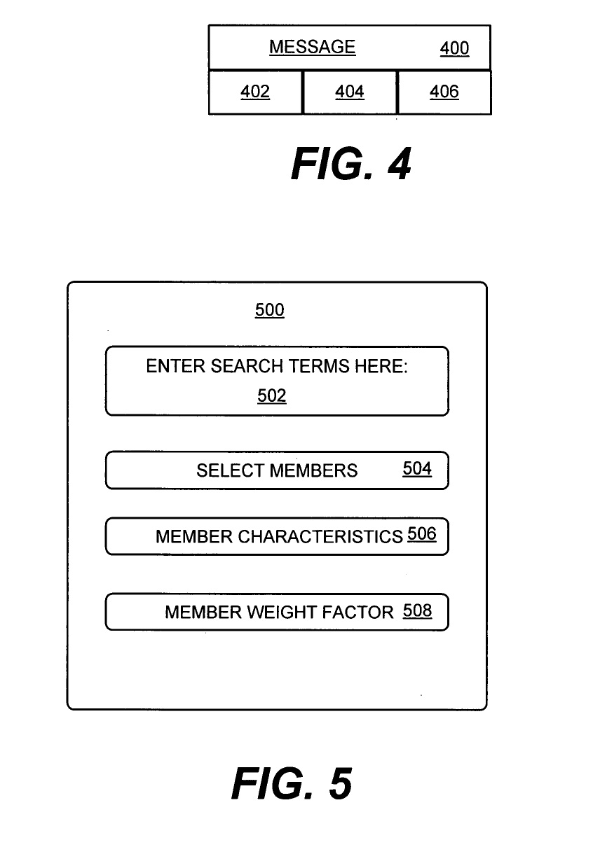

FIG. 5 is an exemplary illustration of a browser window 500 for providing a search request. The browser window 500 includes an input box 502 in which a user may input search parameters. The browser window 500 also includes a member-restrictor tab 504. When the user clicks on the member-restrictor tab 504, the PWUSS 112 may provide the user with a list of members in the user's social network whose member-profiles should be searched. Typically, the user may select all of members. However, in some situations, the user may select a subset of the members.

The browser window 500 also includes a member-characteristic box 506. The user may use the member-characteristic box 506 to provide criteria for restricting which web-usage-histories 326 are searched. If the user inputs information into the member-characteristic box 506, the information is provided to the PWUSS 112. The PWUSS 112 may search member-profiles 328 belonging to members of the user's social network for characteristics related to the inputted information. Having determined which members of the social-network have appropriate characteristics, the PWUSS 112 may then limit the search to the corresponding web-usage histories 326.

The browser window 500 may also include a member weighting factor tab 508. The member weighting factor tab 508 allows the user to assign a weighting factor for those members previously selected. In some embodiments, when the user selects a member using the member-restrictor tab 504, the user can then provide a member weighting factor.

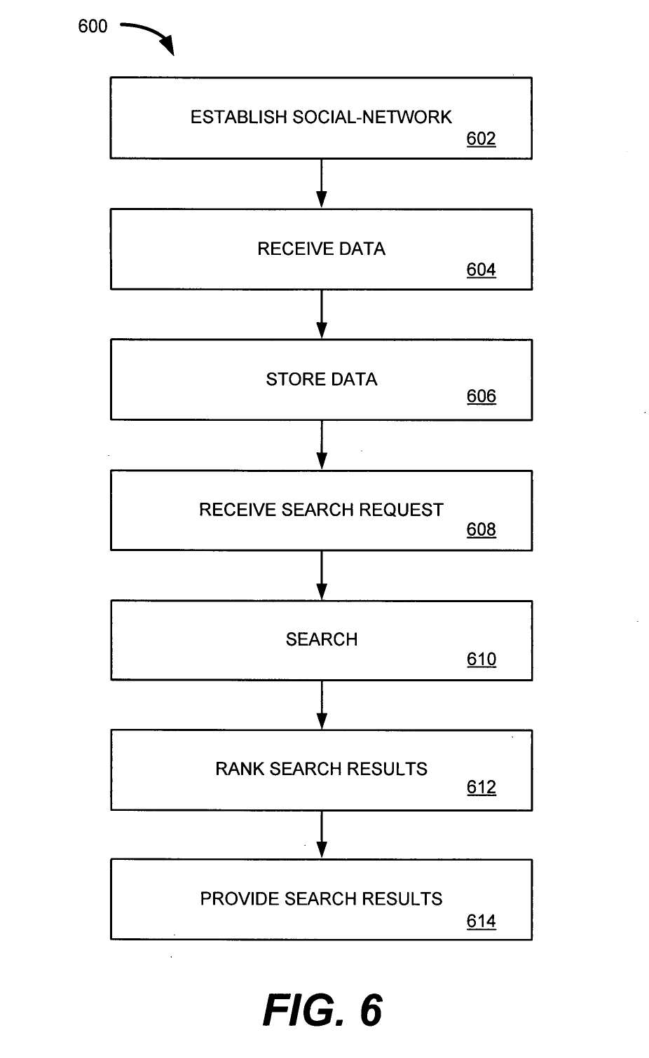

FIG. 6 illustrates steps 600 which may be implemented by the PWUSS 112 and by a user of the PWUSS 112. In step 602, the user establishes an electronic social-network 124 at the WPUSS 112 by enrolling at the WPUSS 112 and sending membership-invitations to his or her acquaintances, friends, family, etc. Those people who respond to the membership-invitations become members of the user's electronic social-network. When people join the WPUSS 112, the people receive the web-usage monitor 218, which is then installed on network communication devices.

In step 604, the PWUSS 112 receives data from web-usage monitors 218. The received data includes the web-usage information. In step 606, the data is stored. In some embodiments, when data is received, the PWUSS 112 retrieves a particular web-usage history 326 and modifies the retrieved web-usage history 326 to include at least a portion of the data. Normally, the data includes a member-identifier from which a particular user of the PWUSS 112 is identified, and the retrieved web-usage history belongs to the particular user of the PWUSS 112.

In some embodiments, the PWUSS 112 aggregates received data into social-network-web-usage-histories 332. When the PWUSS 112 receives web-usage information 113, the PWUSS 112 determines at least one electronic social-network 124 with which the web-usage-information 113 should be associated. The PWUSS 112 then retrieves the social-network-web-usage-histories 332 for the at least one corresponding electronic social-network and then may modify the retrieved social-network-web-usage-histories 332 to include at least a portion of the received web-usage-information 113.

It should be noted that users of the PWUSS 112 may belong to multiple electronic social-networks. Normally every user belongs to their own electronic social-network and to the electronic social-networks from which the users accepted membership-invitations. Thus, when a given user who belongs to multiple electronic social-networks surfs the web, thereby causing the web-usage monitor to provide web-usage information, the social-network-web-usage histories corresponding to the user's social-networks are modified.

In step 608, a PWUSS search request is received. The PWUSS search request may include a member-identifier that identifies the user who submitted the PWUSS search request. Using the member-identifier, the PWUSS 112 may determine the user's electronic social-network. In some embodiments, the PWUSS search request may include a social-network identifier that identifies the electronic social-network of the user who submitted the PWUSS search request. The PWUSS search request includes search parameters and may include further information such as member-restrictors, member characteristics, and/or weighting factors.

In some embodiments, the PWUSS client 216 may provide the PWUSS search request and may include identifying information in the PWUSS search request. Among other things, the PWUSS may use the identifying information for identifying the member who submitted the PWUSS search request and/or identifying an electronic social-network to which the search requesting member belongs.

In step 610, the PWUSS conducts a search of a database having an archive of web-usage histories. In one embodiment, the PWUSS searches web-usage-histories belonging to particular users of the PWUSS. The searched web-usage-histories may belong to selected members of an electronic social-network or the web-usage-histories corresponding to all of the members of the electronic social-network may be searched. In another embodiment, instead of searching individual web-usage-histories, the PWUSS may search a particular social-network-web-usage-history. The particular social-network-web-usage-history corresponds to the social-network of the user of the PWUSS who submitted the PWUSS search request.

In step 612, the PWUSS ranks the historic-usage-search results. The PWUSS may use member weighting factors for ranking the search results, and in step 614, PWUSS provides the user of the PWUSS who submitted the PWUSS search request with the historic-usage-search results.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing search results to users of a search provider, the method comprising the steps of:
receiving, from a particular user, a search request having search parameters;
searching a web-usage history, stored in a database, using the search parameters, wherein the web-usage history includes historical web-usage information for a given user of the search provider; and
providing the particular user with search results based at least upon the search of the web-usage history.

2. The method of claim 1, further including the steps of:
maintaining a plurality of electronic social-networks for users of the search provider, wherein each electronic social-network is comprised of one or more users of the search provider, wherein the particular user is a member of a specific electronic social-network;
determining the specific electronic social-network for which the particular user is a member; and
associating a web-usage history for users of the search provider, wherein each user belonging to the specific electronic social-network has a web-usage history associated therewith;
wherein the step of searching the web-usage history includes:
identifying web-usage histories of users belonging to the specific electronic social-network; and
searching the identified web-usage histories.

3. The method of claim 2, wherein the step of identifying web-usage histories includes the step of excluding the web-usage history associated with the particular user from identification.

4. The method of claim 2, wherein only web-usage histories associated with members of the specific electronic social-network are searched.

5. The method of claim 1, further including the steps of:
maintaining a plurality of electronic social-networks for users of the search provider, wherein each electronic social-network is comprised of one or more users of the search provider;
storing a database of web-usage histories for users of the search provider, wherein each web-usage history is associated with one of the users of the search provider;
receiving web-usage information; and
including at least a portion of the received web-usage information in a web-usage history.

6. The method of claim 5, wherein the web-usage history that includes the portion of the received web-usage information is a specific web-usage history, and further including the step of:
determining the specific web-usage history.

7. The method of claim 6, wherein the received web-usage information includes an identifier, and wherein the identifier is used to determine the specific web-usage history.

8. The method of claim 1, further including the steps of:
providing the search parameters to a search engine;
receiving, from the search engine, non-historic-web-usage search results, wherein the non-historic-web-usage search results are independent of the web-usage history; and
combining the non-historic-web-usage search results with the search results of the web-usage-history.

9. The method of claim 8, wherein the step of combining further includes the steps of:
applying a first weight to the non-historic-web-usage search results and a second weight to the search results of the web-usage-history; and
ranking the weighted non-historic-web-usage search results and the weighted search results of the web-usage-history.

10. The method of claim 1, further including the steps of:
searching a second web-usage history using the search parameters, wherein the second web-usage history includes historical web-usage information for a second given user of the search provider;
applying a first weight to the search results of the first web-usage history and a second weight to the search results of the second web-usage-history; and
ranking the weighted search results of the first web-usage-history and the weighted search results of the second web-usage-history.

11. A system for providing search results, the system comprising:
a server that receives search request from a given user, wherein the user provides a search parameter;
a searchable database having a plurality of web-usage histories stored therein; and
a search engine module in communication with the database, the search engine module receives the search parameter and uses the search parameter to search at least a portion of the plurality of web-usage histories stored in the database and generate search results therefore, wherein the server provides the search results to the given user.

12. The system of claim 11,
a social-network manager module configured to maintain a plurality of electronic social-networks, wherein each electronic social-network is comprised of one or more associated users of the system, wherein the given user is a member of a specific electronic social-network, wherein the social-network manager module is configured to identify the members of the specific electronic social-network; and
wherein the system includes logic embodied in a computer readable medium, the logic configured to perform the steps of:
determining the specific electronic social-network for which the given user is a member; and
associating a web-usage history for users of the search provider, wherein each user belonging to the specific electronic social-network has a web-usage history associated therewith;
wherein the step of searching the web-usage history includes:
identifying web-usage histories of users belonging to the specific electronic social-network; and
searching only the identified web-usage histories.

13. The system of claim 11, wherein the step of identifying web-usage histories includes the step of excluding the web-usage history associated with the given user from identification.

14. A method of searching a web of distributed content servers, the method comprising the steps of:
storing a plurality of web-usage histories in a database;
receiving a search request having search parameters included therein;
searching the database using the search parameters; and
providing a historical web-usage search results based upon the search of the database.

15. The method of claim 14, further including the steps of:
enabling the creation of a plurality of electronic social-networks, each electronic social-network having a plurality of members associated therewith;
associating each one of the plurality of web-usage histories with one of the electronic social-networks; and
determining a particular web-usage history to search.

16. The method of claim 15, wherein the particular web-usage history is associated with a particular electronic social-network, and wherein the search request was submitted by a given member associated with the electronic social-network.

17. The method of claim 15, further including the steps of:
receiving web-usage information for content received by a given member, the given member is associated with a given electronic social-network; and
modifying the web-usage history associated with the given electronic social-network to include at least a portion of the received web-usage information.

18. The method of claim 17, wherein the web-usage information includes at least one of a Uniform Resource Locator and meta-data for content received by the given user.

19. The method of claim 15, wherein the search request includes an identifier, and wherein the particular web-usage history to be searched is determined using the identifier.

20. The method of claim 19, wherein the identifier is a member-identifier.

21. The method of claim 19, wherein the identifier is an electronic social-network identifier.

22. The method of claim 14, further including the steps of:
enabling the creation of a plurality of electronic social-networks, each electronic social-network having a plurality of members associated therewith;
associating each one of the plurality of web-usage histories with one of the members of the electronic social-networks; and
determining a plurality of web-usage histories to search, wherein each one of the web-usage histories to be searched is associated with a member in the same electronic social-network.

23. The method of claim 22, wherein the search request was submitted by a given member associated with the same electronic social-network.

24. The method of claim 22, further including the steps of:
receiving web-usage information for content received by a given member; and
modifying the web-usage history associated with the given member to include at least a portion of the received web-usage information.

25. The method of claim 24, wherein the web-usage information includes at least one of a Uniform Resource Locator and meta-data for content received by the given user.

26. The method of claim 22, wherein the search request includes a member-restrictor; and further including the step of using the member-restrictor to determine the plurality of web-usage histories to be searched.

27. The method of claim 22, wherein the search request includes a weighting factor, and further including the step of ranking the historical web-usage search results using the weighting factor.
